(19) United States
(12) Patent Application Publication
(10) Pub. No.: US 2015/0163300 A1
(43) Pub. Date: Jun. 11, 2015

(54) AUTOMATIC RECREATION OF A PEER-TO-PEER GROUP IN CASE OF GROUP OWNER TERMINATION

(71) Applicant: QUALCOMM Incorporated, San Diego, CA (US)

(72) Inventors: Chinamay Kumar, Hyderabad (IN); Krishna Chaitanya Suryavenkata Emani, Hyderabad (IN); Anil Kumar Daga, Hyderabad (IN)

(73) Assignee: QUALCOMM Incorporated, San Diego, CA (US)

(21) Appl. No.: 14/103,492

(22) Filed: Dec. 11, 2013

(51) Int. Cl. H04L 29/08

(52) U.S. Cl. CPC H04L 67/1046; H04L 67/16

(57) ABSTRACT

Methods, apparatuses, and devices are described for wireless communications in which a group of clients in a peer-to-peer configuration can be automatically recreated after the group owner (GO) is terminated. In one aspect, the current GO of a current group can identify one of the clients as a candidate GO for a next group. The next group is to be formed when the current GO becomes unavailable (e.g., scheduled or unscheduled termination) and the current group is dissolved. In another aspect, the candidate GO can determine when the current GO is unavailable, which results in the current group being dissolved. The candidate GO can then send invitations to clients from the current group to join the next group and can form the next group based on those clients that accept the invitation. The invitations can be sent according to a sequence specified by the current GO before becoming unavailable.

### BACKGROUND

Wi-Fi Direct, also referred to as Wi-Fi peer-to-peer (P2P), is a Wi-Fi standard that allows Wi-Fi devices or stations (STAs) to easily connect and transfer data between each other without the need for a wireless access point (AP). Wi-Fi Direct is being deployed widely in many different scenarios. For example, Wi-Fi Direct is being used to form groups of multiple clients or stations connected in a P2P network configuration. Such groups of clients may include printers, projectors, smart phones, tablets, and laptops to name a few. Wi-Fi devices within a particular group can be from different manufactures.

In a Wi-Fi Direct multi-client network (e.g., P2P group), a group owner (GO) may generally be selected from among the clients (e.g., P2P clients) in the group to provide a similar role to that of a wireless AP. When there is an unscheduled (or scheduled) GO termination, the group is dissolved and cannot be easily restored. The GO may be terminated (e.g., may be unavailable) when, for example, the battery of the GO runs out or when the GO leaves the group. If the group needs to be restored, then all the users need to intervene to create the group again.

Creating a new group in this scenario is not trivial and can be difficult to do. For example, it may be difficult to decide which device is to become the GO in the new group. Users need to make decisions as to which device will become the new GO (to avoid making multiple groups) and instruct all other users to be idle until a new group is formed. Once it is decided which device will be the new GO, all users have to intervene and connect one by one to the new GO, which requires further user involvement (e.g., invitation via personal information number (PIN)/push button configuration (PBC)). The users may also have to make sure PBC overlaps do not happen. It is generally difficult to maintain the above requirements in a multi-client scenario (e.g., when 32 clients are supported). End users may also struggle to make a new connection if the peer devices do not have a good graphical user interface (GUI) like the kind typically found in a printer or a projector.

Therefore, it may be desirable to have a mechanism or protocol to resume or reinstate a P2P group without user intervention after it is dissolved because of unavailability of the GO.

### SUMMARY

The described features generally relate to one or more improved methods, apparatuses, devices, and/or systems for wireless communications. More particularly, the described features generally relate to wireless communications in which a P2P group is recreated automatically (e.g., without user intervention) upon termination of the P2P group GO.

One aspect of automatic P2P group recreation or restoration in case of GO termination includes having a current GO of a current group identify or select one of the clients as a candidate GO for a next group. The P2P group may be configured in a Wi-Fi Direct multi-client network, for example. Each of the clients in the group may be ranked according to different factors to determine which one is more suitable as a candidate GO. The factors may include, but not limited to, the maximum number of clients supported by the client, the type of backhaul internet connection in the client (e.g., 3G, Long Term Evolution (LTE)), support for a specific high priority feature of the group (e.g., display, printer, camera), channel of operation and supported band(s), and battery life. Once the candidate GO is determined, the current GO provides information to clients in the group about the candidate GO.

When the current GO becomes unavailable (e.g., scheduled or unscheduled termination), the current group is dissolved. The candidate GO and the other clients in the group can determine when the current GO is unavailable. When the current GO becomes unavailable, the clients determine that and wait for invitations from the candidate GO. When the candidate GO determines that the current GO is unavailable, it starts to beacon and then send invitations to each of the clients connected in the current network to join the new group. The clients accept the invitation from the new GO by listening on the appropriate channel and by recognizing the candidate GO based on information provided by the current GO. The invitations can be sent by the candidate GO according to a sequence specified by the current GO before becoming unavailable.

According to at least a first set of illustrative embodiments, a method for wireless communications, includes: determining whether a current group owner (GO) in a current group of clients is unavailable; transmitting invitations to clients in the current group to join a next group of clients when a determination is made that the current GO is unavailable, the current group of clients being dissolved in response to the unavailability of the current GO; and forming the next group of clients based at least in part on the clients from the current group of clients that accept the invitation to join the next group of clients.

In certain examples of the method, each of the current group of clients and the next group of clients is configured in a peer-to-peer network.

In certain examples of the method, determining whether a current GO in a current group of clients is unavailable includes detecting that a beacon from the current GO has not been received during a predefined period of time.

In certain examples of the method, transmitting invitations to clients in the current group includes transmitting invitations to clients in the current group according to a sequence specified by the current GO before the current GO became unavailable.

In certain examples of the method, transmitting invitations to clients in the current group according to a sequence specified by the current GO includes transmitting an invitation to a next client in the sequence after a current client in the sequence accepts its respective invitation.

In certain examples of the method, transmitting invitations to clients in the current group according to a sequence specified by the current GO includes waiting a predefined period of time to transmit an invitation to a next client in the sequence when a connection attempt with a current client in the sequence is unsuccessful.

In certain examples, the method also includes receiving configuration information to operate as GO for the next group of clients, the configuration information being received from the current GO before the current GO became unavailable.

In certain examples, the method also includes operating as the GO for the next group of clients when the next group of clients is formed.

In certain examples of the method, forming the next group of clients includes receiving one or more acceptances to the invitations through a listening channel specified by the current GO before the current GO became unavailable.

According to at least a second set of illustrative embodiments, an apparatus for wireless communications, includes: a detector configured to determine whether a current GO in a current group of clients is unavailable; and a group former. The group former may be configured to transmit invitations to clients in the current group to join a next group of clients when a determination is made that the current GO is unavailable, the current group of clients being dissolved in response to the unavailability of the current GO, and to form the next group of clients based at least in part on the clients from the current group of clients that accept the invitation to join the next group of clients.

In certain examples, the apparatus for wireless communications may implement one or more of the aspects of the method described above with respect to the first set of illustrative embodiments. For example, the apparatus may be additionally configured with one or more additional components for implementing one or more of the examples of the method described above with respect to the first set of illustrative embodiments.

In certain examples of the apparatus, each of the current group of clients and the next group of clients is configured in a peer-to-peer network.

In certain examples of the apparatus, the detector may be further configured to detect that a beacon from the current GO has not been received during a predefined period of time.

In certain examples of the apparatus, the group former may be further configured to transmit invitations according to a sequence specified by the current GO before the current GO became unavailable.

In certain examples of the apparatus, the group former may be further configured to transmit of an invitation to a next client in the sequence after a current client in the sequence accepts its respective invitation.

In certain examples of the apparatus, the group former may be further configured to wait a predefined period of time to transmit an invitation to a next client in the sequence when a connection attempt with a current client in the sequence is unsuccessful.

In certain examples, the apparatus may further include a receiver configured to receive configuration information to operate as GO for the next group of clients, the configuration information being received from the current GO before the current GO became unavailable.

In certain examples, the apparatus may further include a GO operations manager configured to implement GO operations for the next group of clients when the next group of clients is formed.

In certain examples of the apparatus, the group former may be further configured to receive one or more acceptances to the invitations through a listening channel specified by the current GO before the current GO became unavailable.

According to at least at third set of illustrative embodiments, a computer program product for wireless communications, includes a non-transitory computer-readable medium storing instructions executable by a processor to cause a processor to: determine whether a current group owner (GO) in a current group of clients is unavailable; transmit invitations to clients in the current group to join a next group of clients when a determination is made that the current GO is unavailable, the current group of clients being dissolved in response to the unavailability of the current GO; and form the next group of clients based at least in part on the clients from the current group of clients that accept the invitation to join the next group of clients.

In certain examples, the computer program product may implement one or more aspects of the method described above with respect to the first set of illustrative embodiments. For example, the computer-readable medium may include instructions executable by the processor to cause the processor to implement one or more of the examples of the method described above with respect to the first set of illustrative embodiments.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of a wireless local area network (WLAN) according to various embodiments;

FIG. 2A shows a diagram that illustrates an example of a P2P group according to various embodiments;

FIG. 2B shows a diagram that illustrates an example of a next P2P group formed after the GO of the previous P2P group is terminated according to various embodiments;

FIG. 3 shows a flowchart that illustrates an example of identifying a candidate GO according to various embodiments;

FIG. 4 shows a flowchart that illustrates an example of a candidate GO leaving a network according to various embodiments;

FIG. 5 shows a flowchart that illustrates an example of an unscheduled termination of a current GO according to various embodiments;

FIG. 6A shows a diagram that illustrates an example of a software-enabled access point (SAP) network according to various embodiments;

FIG. 6B shows a diagram that illustrates an example of an SAP network with offload SAP according to various embodiments;

FIG. 7 shows a flowchart that illustrates an example of identifying a candidate SAP according to various embodiments;

FIG. 8 shows a flowchart that illustrates an example of a candidate SAP leaving a network according to various embodiments;

FIGS. 9 and 10 show flowcharts that illustrate examples of an unscheduled and scheduled termination of a current SAP according to various embodiments;

FIGS. 11A and 11B show diagrams that illustrate examples of devices (e.g., stations) for P2P group recreation in wireless communications according to various embodiments;

FIG. 12 shows a diagram that illustrates an example of a current GO manager according to various embodiments;

FIG. 13 shows a diagram that illustrates an example of a candidate GO manager according to various embodiments;

FIG. 14 shows a diagram that illustrates an example of a device (e.g., stations) for use SAP offload in wireless communications according to various embodiments;

FIG. 15 shows a block diagram that illustrates an example of station architecture according to various embodiments; and

FIGS. 16 and 17 are flowcharts of examples of methods for automatic P2P group recreation (e.g., at a station) according to various embodiments.

### DETAILED DESCRIPTION

Described embodiments are directed to methods, devices, and apparatuses for wireless communications in which in which at least part of a P2P group (e.g., a Wi-Fi Direct multi-client network) is automatically recreate without user intervention upon termination of the P2P group GO because the GO is unavailable. In one aspect, a current GO in a current group of clients may identify a candidate GO from the current group of clients. The candidate GO may be identified or selected after ranking at least a portion of the clients in the group according to one or more factors or metrics. The candidate GO may then operate as a GO for a next group of clients to be formed when the current group of clients is dissolved in response to unavailability (e.g., termination) of the current GO. Termination of the current GO may be scheduled or unscheduled. The candidate GO identified by the current GO may be configured to form the next group of clients when the current GO is unavailable. The identified candidate GO can form the next group of clients by automatically transmitting (in sequential order) invitations to one or more of the current group of clients to join the next group of clients when the current GO is unavailable.

For a client of a P2P group to be considered as a candidate GO, the client may need to have the P2P group reinstatement or recreation feature enabled (e.g., turned ON). This feature may be enabled during operation or as part of a start-up configuration of the client device. Once enabled, the feature will indicate that P2P clients joining the network support recreation of the group in case of termination of the GO. One way to provide the indication is through vendor-specific information elements (IEs) in an Association Request (Assoc. Req.) packet, an Association Response (Assoc. Rsp.) packet, and/or in beacon signals.

The various techniques described herein for wireless communications using an automatic P2P group recreation mechanism in case of GO termination are described with respect to WLAN or Wi-Fi networks operating in a peer-to-peer configuration. A WLAN or Wi-Fi network may refer to a network that is based on the protocols described in the various IEEE 802.11 standards (e.g., IEEE 802.11a/g, 802.11n, 802.11ac, 802.11ah, etc.), for example. However, the same or similar techniques may also be used in any wireless network (e.g., a cellular network). For example, the same or similar techniques may be used for various wireless communications systems such as cellular wireless systems, Peer-to-Peer wireless communications, ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), Wi-Fi, IEEE 802.16 (WiMAX), IEEE 802.20, Flash-OFDM, etc. UTRA and E-UTRA are part of Universal Mobile Telecommunication System (UMTS). 3GPP Long Term Evolution and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

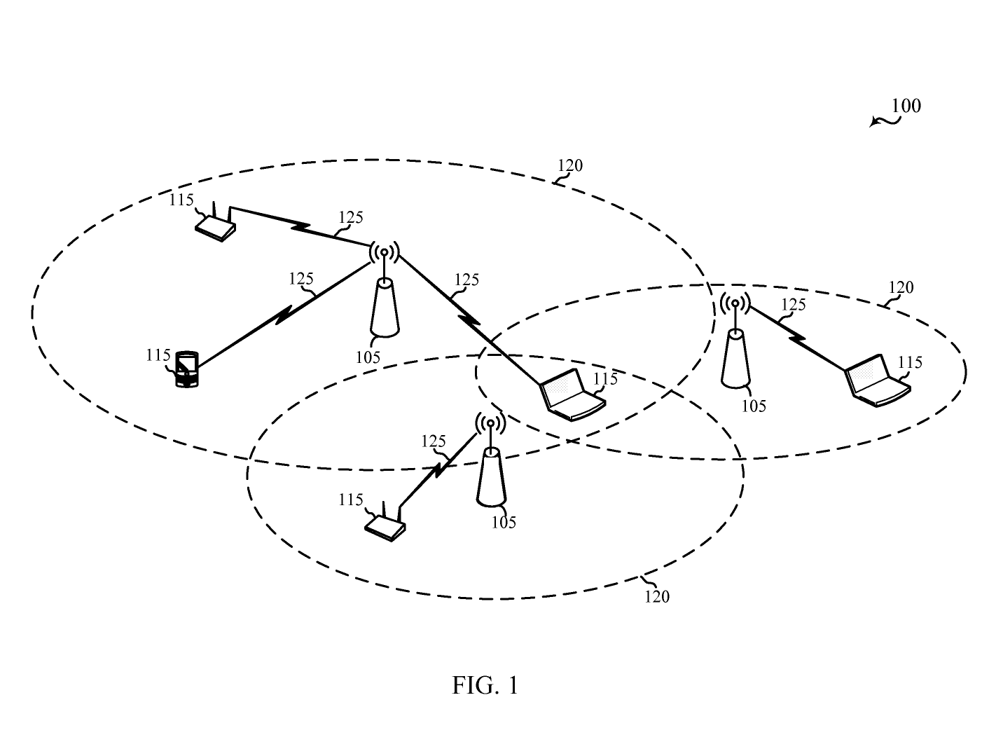

FIG. 1 shows a diagram 100 that includes an example of a WLAN or Wi-Fi network. An access point (AP) 105 (i.e., network device) may generate a wireless local area network, such as an IEEE 802.11 network, with client devices 115. The client devices 115, also referred to as wireless stations, stations, or STAs, may be distributed or deployed within a coverage area 120 of the WLAN. Each of the stations 115 may associate and communicate (using communication links 125) with one of the APs 105. Each AP 105 has a coverage area 120 such that stations 115 within that area can typically communicate with the AP 105. As shown in FIG. 1, a station 115 can be covered by more than one AP 105 and can therefore associate with different APs at different times depending on which one provides a more suitable connection. A set of stations 115 that communicate with each other may be referred to as a basic service set (BSS). An extended service set (ESS) is a set of connected BSSs and a distribution system (DS) (not shown) is used to connect access points in an extended service set.

In some instances, several of the stations 115 may connect to each other to establish a peer-to-peer network (e.g., a Wi-Fi Direct multi-client network). In such a network or group, one of the stations (clients) operates as the access point for the group and is typically referred to as the group owner or GO. When the GO needs to leave the group (e.g., is terminated), because of a scheduled event or because of an unscheduled event (e.g., battery runs low), the network or group dissolves and may need to be recreated. Using an automatic mechanism in which the total or partial recreation of the group occurs without user intervention may be supported by the GO and by one or more of the other clients in the group.

In some instances, one of the stations 115 may operate as an access point to other stations and may be referred to as a software access point or SAP. When the SAP becomes unavailable (e.g., is terminated), because of a scheduled event or because of an unscheduled event (e.g., battery runs low), another station that can operate as a SAP may be used instead. Moreover, when a station that may perform better as a SAP than the current SAP is available, that station may be used to replace the current SAP.

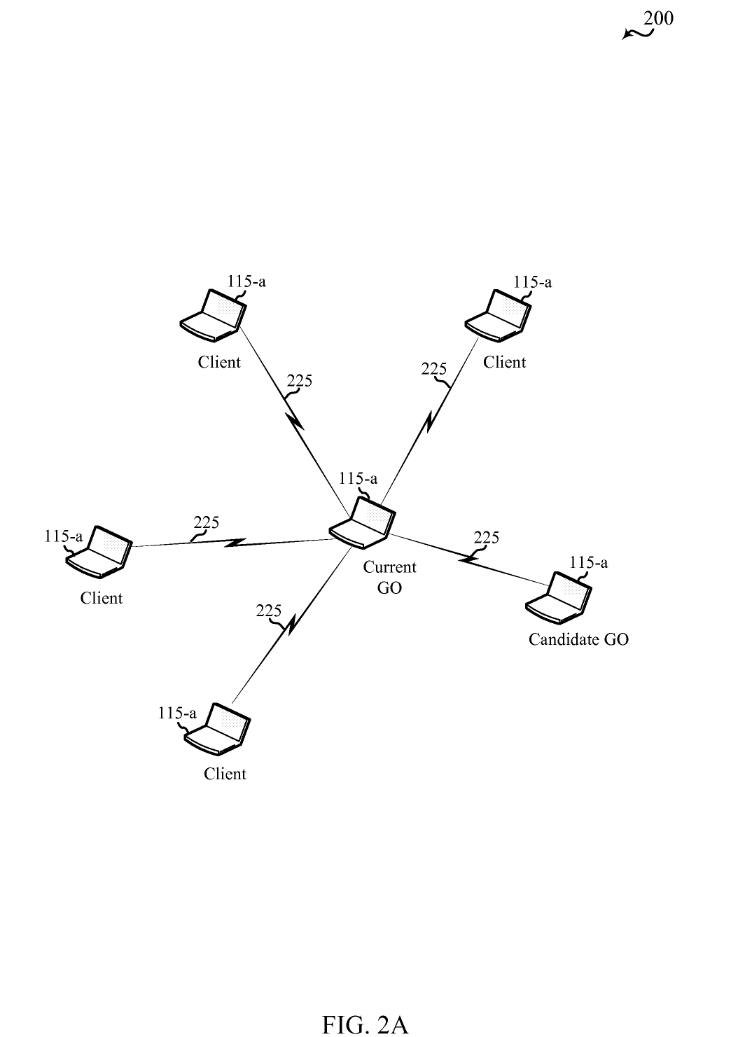

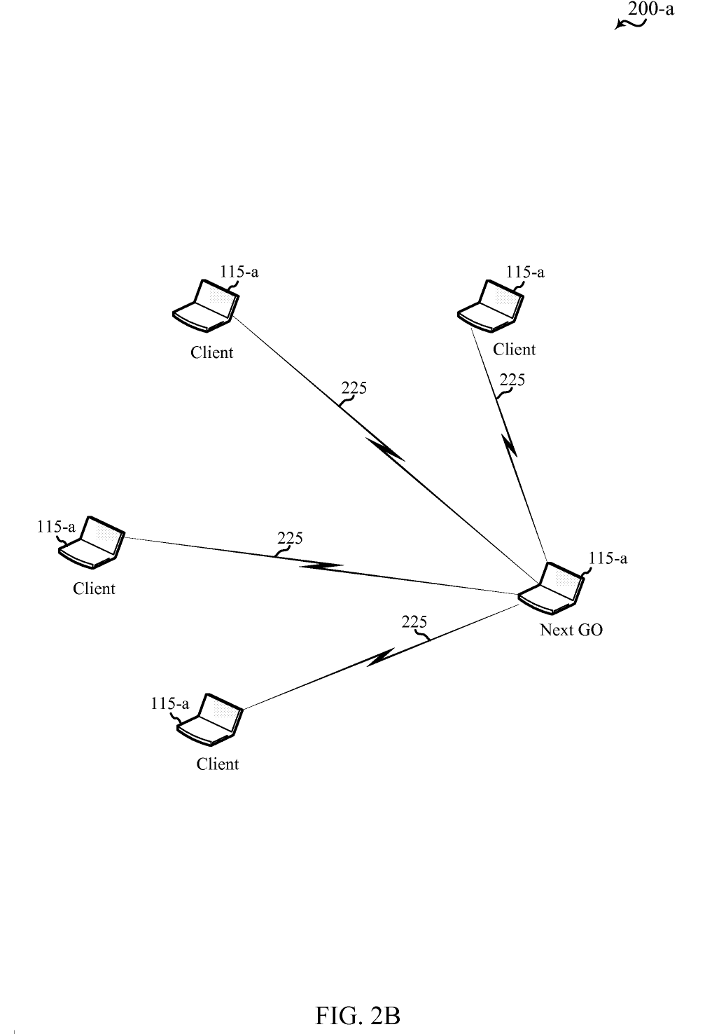

FIGS. 2A-17 described below provide additional details on various aspects of handling automatic recreation of a P2P group in case of GO termination and/or handling SAP offloading in case of SAP termination.

Referring to FIG. 2A, a diagram 200 is shown that illustrates multiple stations 115-a configured in a peer-to-peer network (e.g., Wi-Fi Direct multi-client network) and communicate with each other using communication links 225. The stations 115-a may be examples of the stations 115 of FIG. 1. One of the stations (at the center of the network) is shown to be the current group owner or GO and another station is shown to be a candidate GO. The various stations that are part of the network or group may be referred to as clients.

Implementing an automatic P2P group recreation in the network or group shown in FIG. 2A may include having the P2P group recreation feature turned ON or enable by the user in the P2P device (e.g., station 115-a). In some instances, the feature may also be turned ON or enable upon starting up the device. P2P devices (e.g., stations 115-a) may include information elements (e.g., vendor specific IEs) in an association request (Assoc. Req.) packet and/or in an association response (Assoc. Rsp.) packet used during association or group formation. A P2P device that becomes the current GO may include vendor specific information elements indicating support for resuming of P2P group in case of termination (e.g., unscheduled termination) of the current GO. When the number of P2P clients in a current group is more than one, the current GO may start the procedure of identifying or selecting a candidate GO based on capabilities indicated in the IEs of Assoc. Req. The capabilities may include, but need not be limited to, maximum number of clients supported, internet connections in the current GO (e.g., 3G, LTE), support for specific high priority feature for the group such as display, printer, camera, channel(s) of operation and/or supported band(s), and battery life.

The current GO may include the following information elements in beacons to indicate to the associated P2P clients (e.g., clients in the P2P group) details about the offload or candidate GO that has been selected (e.g., device name, MAC address, group capabilities, operating channel, and listen channel). In some instances, the current GO may indicate that channel 1 (CH1) is to be used as the listen channel in order to reduce scan time/group resumption time.

When a new P2P client joins the P2P group of FIG. 2A, the current GO may determine again which P2P client is the best candidate GO by comparing the new device capabilities and the previously decided candidate GO. If a different candidate GO is identified by the current GO, then the current GO will update the information about the candidate GO to the clients in the group through beacon signals. Once a candidate GO is identified by the current GO, the candidate GO gets P2P client information from the current GO and updates its client list.

Referring to FIG. 2B, a diagram 200-s is shown that illustrates the P2P group of FIG. 2A after the current GO is terminated and a next group is formed by the candidate GO, which is now operating as a next GO for the next group. In this scenario, when the current GO is terminated or becomes unavailable (e.g., unscheduled termination), the P2P clients can detect that the current GO is not available and go to a listen state on the appropriate listen channel (e.g., CH 1). The candidate GO may also detect that the current GO is not available and may start broadcasting beacons in an auto GO mode using the listen channel (e.g., CH 1) indicated by the current GO before the current GO became unavailable. Both the clients and the candidate GO may determine that the current GO is unavailable because, for example, beacon signals from the current GO have not been received for a predefined period of time.

With the current GO terminated, and the current group dissolved as a result, the candidate GO may now become or operate as a new or next GO and may start transmitting invitations (e.g., P2P Invite using PBC) to the clients that were part of the group before it dissolved. The invitations may be sent one at a time in a same order or sequence as specified by the current GO before it became unavailable. When a P2P client gets an invitation from the next GO, the P2P client may recognize or identify the MAC address and the device name of the next GO and may accept the invitation without the need for end user intervention. When the connection is successful between the next GO and the invited P2P client, the next GO may send an invitation to a next P2P client from the now-dissolved P2P group in accordance with the sequence provided by the current GO. In case of an unsuccessful connection attempt with a P2P client, the next GO may wait for some time before inviting a next P2P client to join the next group.

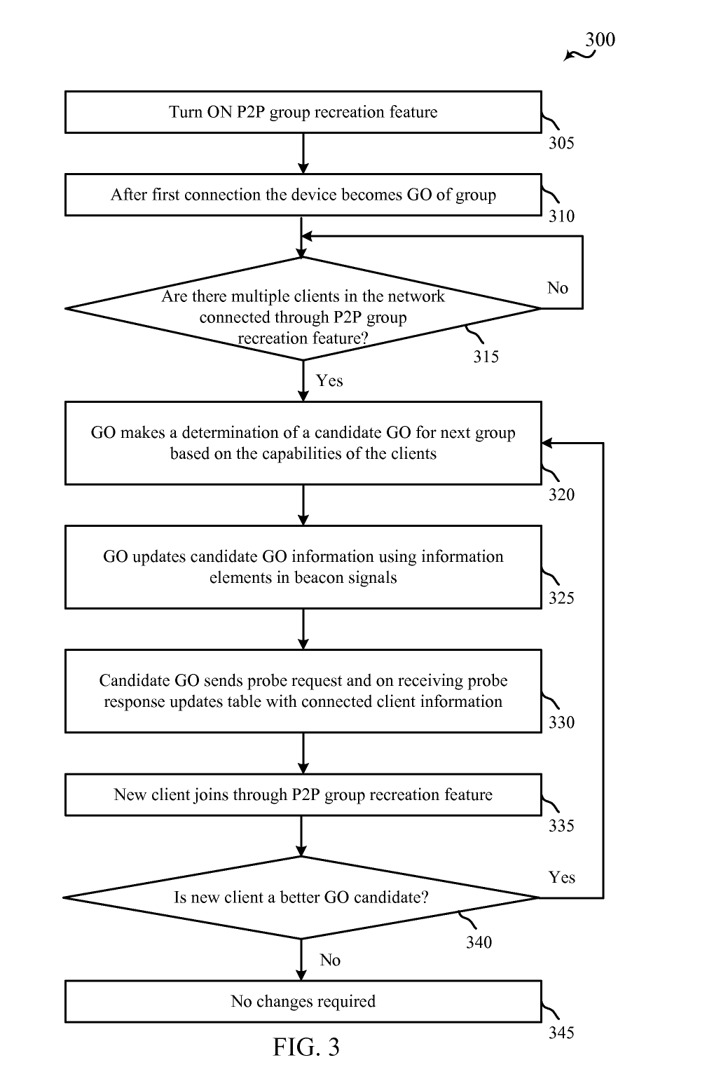

FIG. 3 is a flow chart illustrating an example of a method 300 for wireless communications in which a candidate GO is identified by a current GO. For clarity, the method 300 is described below with reference to one of the stations, devices, and components shown in FIGS. 1, 2A, 2B, 11A, 11B, 12, 13, and/or 15. In one embodiment, one of the stations may execute one or more sets of codes to control the functional elements of the station to perform the functions described below.

At block 305, a device (e.g., station operating as the current GO of FIG. 2A) may turn ON or enable a P2P group recreation feature that allows recreation of a group, or at least part of the group, without user intervention.

At block 310, after a first client connects to the device, the device may become the GO of the group (e.g., current GO).

At block 315, the device may determine whether there is more than one client connected to the device through the P2P group recreation feature. When the number of clients is at least two, the process may proceed to block 320, otherwise the process remains at block 315.

At block 320, the GO may determine a candidate GO for a next group to be formed in case the GO is terminated. The candidate GO is determined based on the capabilities of the clients connected to the GO. Those capabilities may include, but need not be limited to, the maximum number of clients supported by the client, the type of internet connection in the client (e.g., 3G, Long Term Evolution (LTE)), support for a specific high priority feature of the group (e.g., display, printer, camera), channel of operation and supported band(s), and battery life.

At block 325, the GO may update information about the candidate GO to clients in the group by using information elements in the beacon signals broadcast to the clients.

At block 330, the client or station selected as the candidate GO may send probe request to the GO to obtain information about the associated clients. The candidate GO may receive probe responses from the current GO and may update a table that includes information about the clients with information provided in the probe responses.

At block 335, a new client may join the group through the P2P group recreation feature.

At block 340, the GO may determine whether the new client may be a better GO candidate than the candidate GO already selected. A better candidate may be one in which one or more of the capabilities described above is better suited to operate as the GO. When the new client may be a better GO candidate, the process may proceed to block 320, otherwise the process proceeds to block 345 in which no change is made to the selected candidate GO.

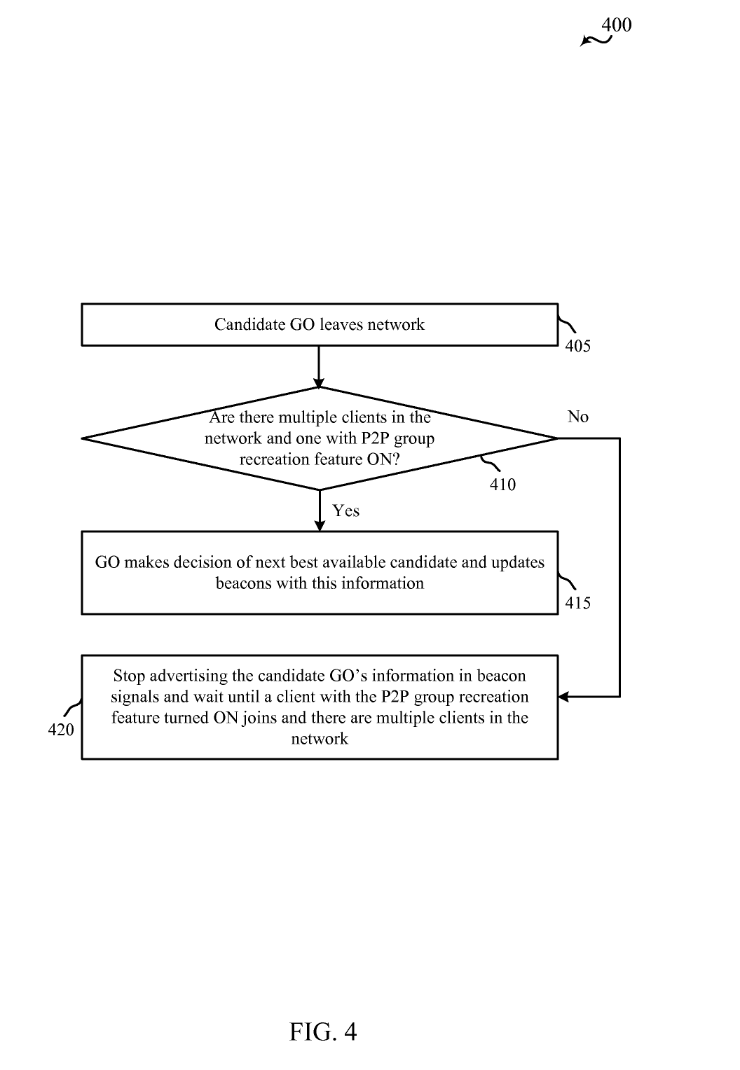

FIG. 4 is a flow chart illustrating an example of a method 400 for wireless communications in which a candidate GO leaves the network. For clarity, the method 400 is described below with reference to one of the stations, devices, and components shown in FIGS. 1, 2A, 2B, 11A, 11B, 12, 13, and/or 15. In one embodiment, one of the stations may execute one or more sets of codes to control the functional elements of the station to perform the functions described below.

At block 405, a candidate GO (e.g., station identified as the candidate GO of FIG. 2A) may leave a network (e.g., P2P group) after it is identified or selected by a current GO (e.g., station identified as the current GO of FIG. 2A).

At block 410, the current GO may determine whether there are other clients in the network and whether one of those clients has a P2P group recreation feature turned ON or enabled. When no other client is available to take on the role of a candidate GO, the process proceeds to block 420, otherwise the process proceeds to block 415.

At block 415, the current GO may determine or decide a next best available candidate and may transmit beacon signals with updated information about the candidate GO.

At block 420, the current GO may stop advertising the information about the candidate GO in beacon signals and may wait until a client with the P2P group recreation feature turned ON joins and there are multiple clients in the network.

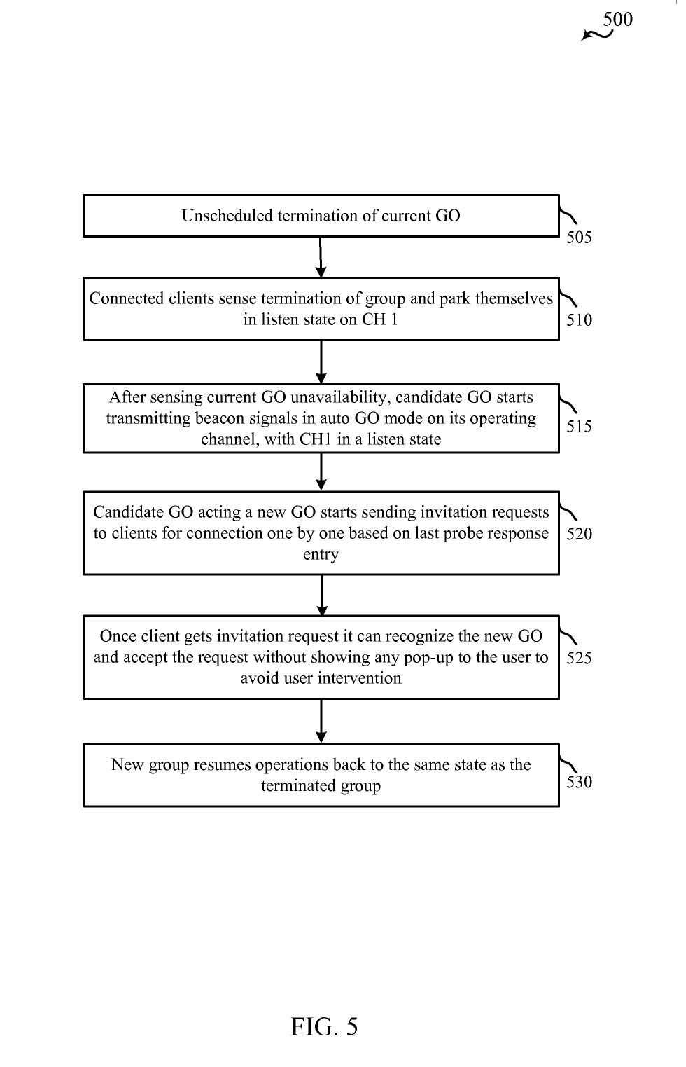

FIG. 5 is a flow chart illustrating an example of a method 500 for wireless communications in which there is an unscheduled termination of a current GO. For clarity, the method 500 is described below with reference to one of the stations, devices, and components shown in FIGS. 1, 2A, 2B, 11A, 11B, 12, 13, and/or 15. In one embodiment, one of the stations may execute one or more sets of codes to control the functional elements of the station to perform the functions described below.

At block 505, a current GO (e.g., the current GO of FIG. 2A) may have an unscheduled termination (e.g., battery runs out, out of range).

At block 510, clients initially connected to the current GO as part of the group may sense or detect that the current GO is unavailable and that the group is terminated or dissolved. The clients may then park themselves in a listen state on channel 1 (CH1) as previously instructed by the current GO in case of termination.

At block 515, after sensing that the current GO is unavailable, the candidate GO may start transmitting beacon signals (i.e., beaconing) in an auto GO mode on its operating channel, with CH1 in a listen state, as instructed by the beacons of the current GO.

At block 520, the candidate GO, now acting as the new or next GO, may send invitation requests to clients one by one based on the last probe response entry.

At block 525, once a client receives an invitation request and recognizes the new GO (from information previously provided by the current GO), the client may accept the invitation without showing any pop-up (on the client's display) to the user to avoid the need for user intervention.

At block 530, the new group is formed and clients from the terminated group resume operation as part of the new group. For example, the new group may resume operations to the same or similar state as the terminated group.

As noted above, in addition to peer-to-peer networks such as Wi-Fi Direct multi-client network, WLAN or Wi-Fi devices or stations may also be used in software-enabled access point (SAP) applications. Although the role of the AP has traditionally been performed by a stand-alone, dedicated piece of equipment, a current trend is to provide a wider range of devices, such as mobile phones, with the capability to act as an AP. Such a device may be known as a SAP. In some cases, the size of the network supported by the AP may be substantial, and may include up to 32 or more client stations. In addition to managing communications between the client stations, an important feature of the SAP may be to provide access to a wide area network (WAN), such as the Internet. The SAP may provide such access through a wireless communication protocol that is independent of the WLAN transceiver. For example, the wireless communication protocol may be a cellular technology such the Radio Access Technologies described above.

Given that many devices may be connected to a SAP and rely on it for providing a functioning WLAN, there may be instances in which transitioning the role of SAP from one device to another may be warranted. For example, if the current SAP becomes disabled, such as by exhausting its battery, another station currently associated with the WLAN that has SAP capabilities may take over the management of the WLAN. Alternatively, if it is determined that an associated station has more desirable SAP capabilities than available through the current SAP, that station may be given the role of SAP for the WLAN.

Therefore, it may be desirable to implement a procedure or protocol for automatically resuming the network after an unexpected termination of the current SAP, or for improving the network with a superior SAP candidate from among STAs in the network.

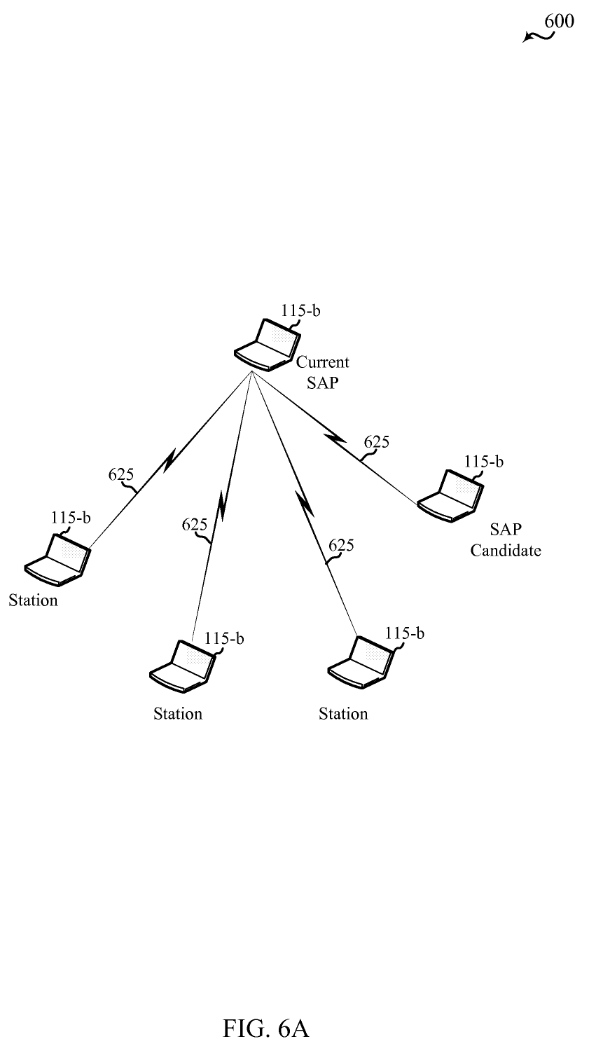

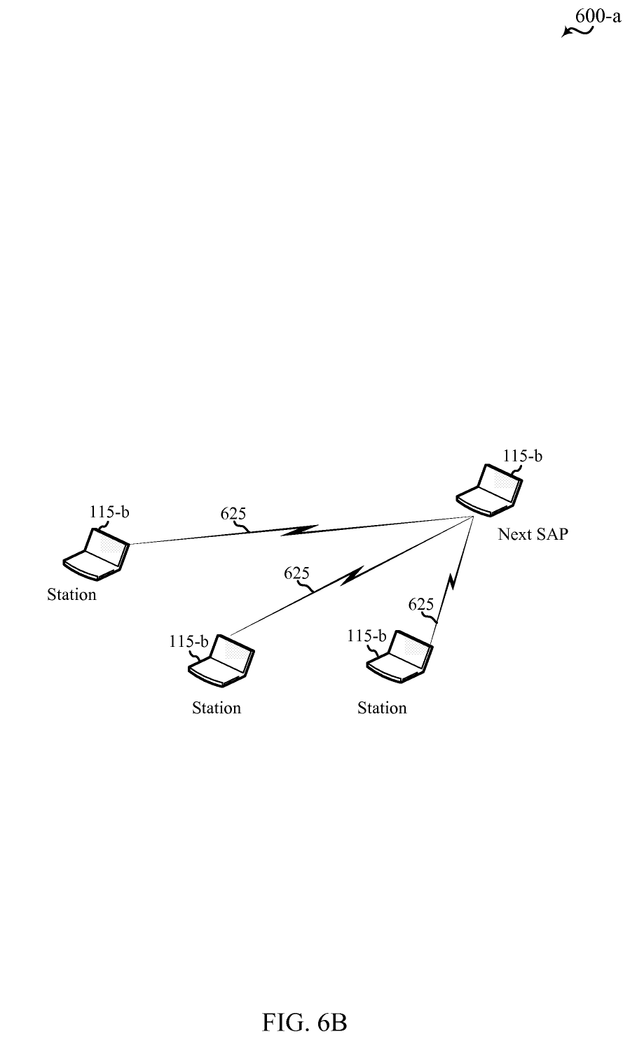

FIG. 6A shows a diagram 600 that illustrates an example of a SAP network according to various embodiments. In this diagram, stations 115-b may be configured in such a way as to have one of the stations operate as a SAP and the other stations connect to the SAP via communication links 625 as they would typically connect to a stand-alone access point. The stations 115-b may be examples of the station 115 and 115-a of FIGS. 1, 2A, and/or 2B. The SAP may be referred to as the current SAP and an offload candidate for taking over SAP operations may be referred to as a SAP candidate. FIG. 6B shows a diagram 600-a that illustrates the new network configuration when the current SAP is terminated or becomes unavailable and the candidate SAP becomes the new or next SAP. In this case, the stations 115-b may disassociate from the current SAP and associate with the next SAP.

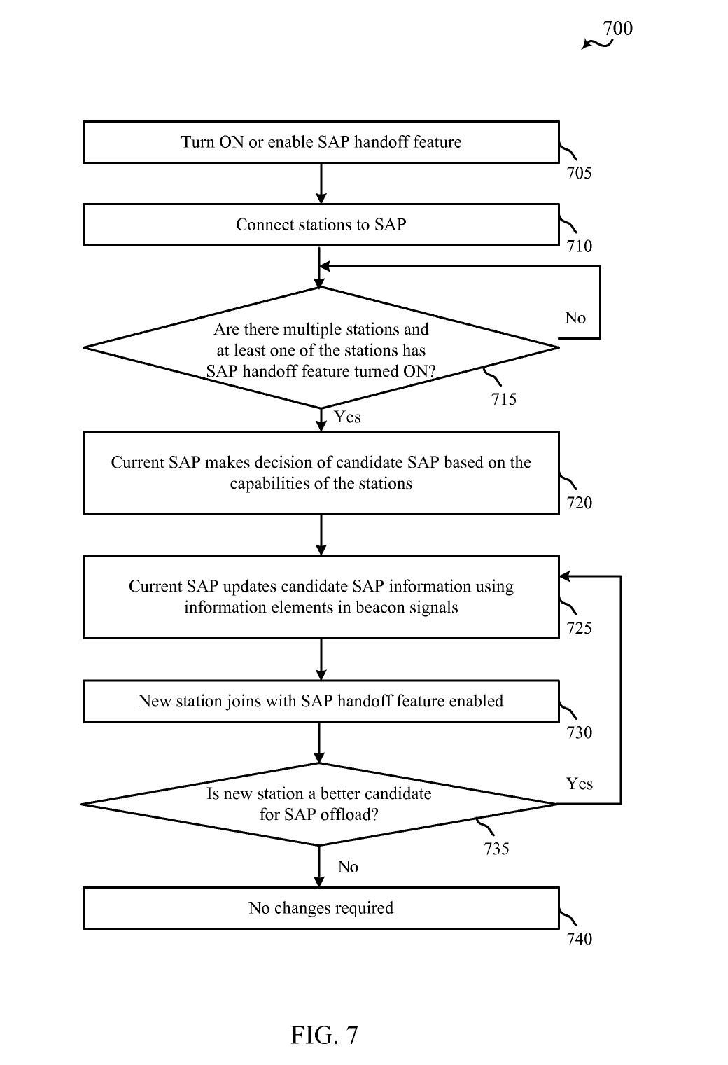

Referring to FIG. 7, is a flow chart illustrating an example of a method 700 for wireless communications in which a candidate SAP is identified. For clarity, the method 700 is described below with reference to one of the stations, devices, and components shown in FIGS. 1, 6A, 6B, 14, and/or 15. In one embodiment, one of the stations may execute one or more sets of codes to control the functional elements of the station to perform the functions described below.

At block 705, a user may turn ON or enable a SAP handoff feature in a device (e.g., station 115-b operating as current SAP in FIG. 6A).

At block 710, stations (e.g., stations 115-b) may connect to the current SAP as clients of the SAP network. Clients of the SAP network may be connected to the network with or without the SAP handoff feature. Clients that connect with the SAP handoff feature enabled will each indicate that it has the capabilities to perform SAP functions in the Assoc. Req. packet upon joining the network. These clients will be presumed to be willing to assume the SAP function if called upon. Clients that join the network in a legacy mode (e.g., not enabling the SAP handoff feature) may be presumed to either not have SAP capability or to be unwilling to assume the SAP role for the network. The SAP handoff feature of a particular client may be enabled by the user or may be supported in default mode. Clients that connect with the SAP handoff feature enabled may have (vendor specific) information elements (IEs) added to their respective Assoc. Req. packet to indicate, for example, the maximum number of clients they may support, the type of Internet connection they may support as SAP such as 3G/LTE and the like, and their supported channels or bands of operation. Other information that may be relevant to SAP operation and that may be used in evaluating SAP capabilities may also be communicated as IEs. Such information may include, but need not be limited to, remaining battery life, IEEE 802.11ac support, dual band or single band support.

At block 715, the current SAP may determine whether there are multiple stations connected and whether at least one of the stations has the SAP handoff feature turned ON. When that is the case, the process may proceed to block 720, otherwise the process returns to block 715.

At block 720, the current SAP may make a decision as to which of the connected stations may be a suitable candidate SAP (e.g., station 115-b operating as candidate SAP in FIG. 6A) based on the capabilities of the connected stations.

At block 725, the current SAP may use beacon signals to update the stations with which it is associated in regard to the relevant information about the offload or candidate SAP. For example, the current SAP may update information such as basic service set identification (BSSID) as well as channel/band of operation in the beacons. The service set identification (SSID) and security/passphrase of the candidate SAP may be the same as those of the current SAP.

At block 730, a new station may join the SAP network with the SAP handoff feature enabled.

At block 735, the current SAP may determine (e.g., recalculate) which of the connected stations is the best offload or candidate SAP by comparing the device capabilities of the newly added station to the previously selected candidate SAP. If the new station added with the SAP handoff feature turned ON or enabled has better capabilities than the previous selection, the current SAP may proceed to block 725 and again update the network using information elements in the beacon signals that provide information about the new station. Otherwise, the process proceeds to block 740 and no changes are required to the candidate SAP selection.

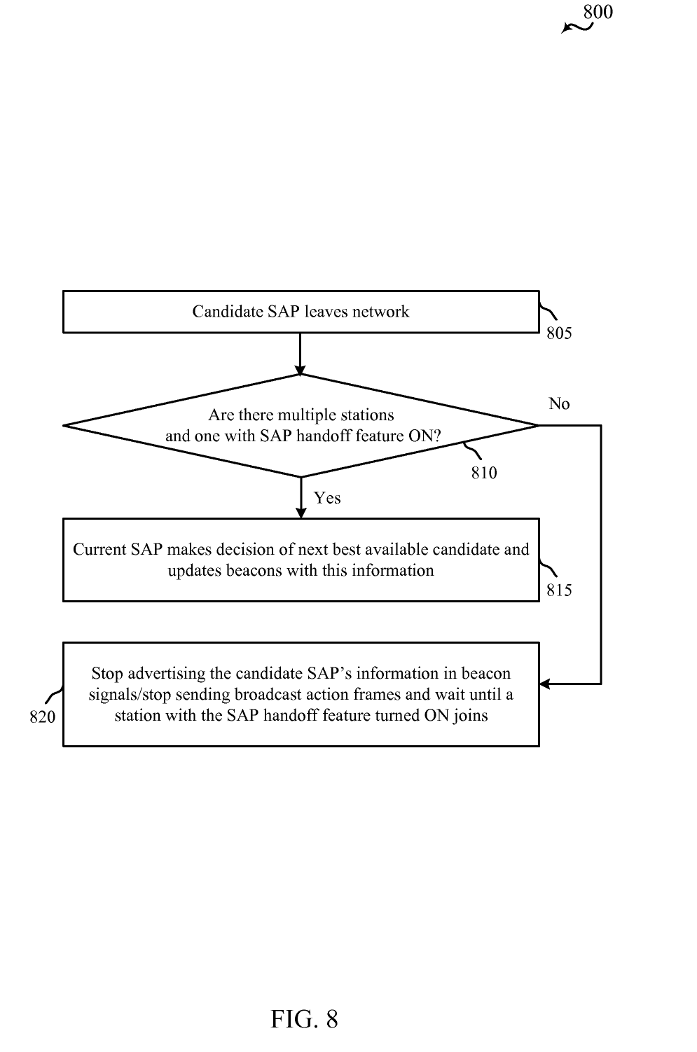

FIG. 8 is a flow chart illustrating an example of a method 800 for wireless communications in which a candidate SAP leaves the network because of a scheduled or unscheduled termination. For clarity, the method 800 is described below with reference to one of the stations, devices, and components shown in FIGS. 1, 6A, 6B, 14, and/or 15. In one embodiment, one of the stations may execute one or more sets of codes to control the functional elements of the station to perform the functions described below.

At block 805, a candidate SAP (e.g., station identified as the candidate SAP of FIG. 6A) may leave a network (e.g., SAP network) after it is identified or selected by a current SAP (e.g., station identified as the current SAP of FIG. 6A).

At block 810, the current SAP may determine whether there are other stations in the network and whether one of those stations has a SAP handoff feature turned ON or enabled. When no other station is available to take on the role of a candidate SAP, the process proceeds to block 820, otherwise the process proceeds to block 815.

At block 815, the current SAP may determine or decide a next best available candidate and may transmit beacon signals with updated information about the candidate SAP.

At block 820, the current SAP may stop advertising information about the candidate SAP in beacon signals and may stop sending broadcast action frames. The current SAP may wait until a station with the SAP handoff feature turned ON joins the SAP network.

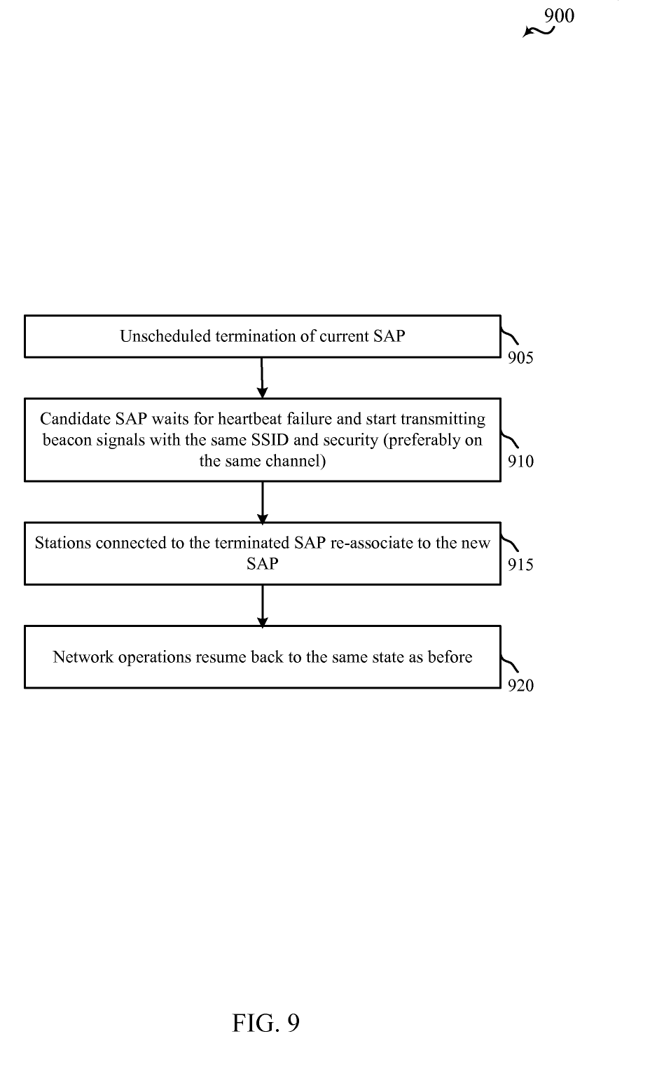

FIG. 9 is a flow chart illustrating an example of a method 900 for wireless communications in which there is an unscheduled termination of a current SAP. For clarity, the method 900 is described below with reference to one of the stations, devices, and components shown in FIGS. 1, 6A, 6B, 14, and/or 15. In one embodiment, one of the stations may execute one or more sets of codes to control the functional elements of the station to perform the functions described below.

At block 905, a current SAP (e.g., the current SAP of FIG. 6A) may have an unscheduled termination (e.g., battery runs out, out of range).

At block 910, the candidate SAP (e.g., the candidate SAP of FIG. 6A) may wait for a heartbeat failure (e.g., missed timeout) and start transmitting beacon signals with the same SSID and security as the terminated SAP. The beacon signals may be preferably transmitted in the same channel used by the terminated SAP.

At block 915, stations connected to the terminated SAP may re-associate to the new or next SAP (the candidate SAP).

At block 920, network operations may resume using the new or next SAP that are back to the same or similar state as before the termination.

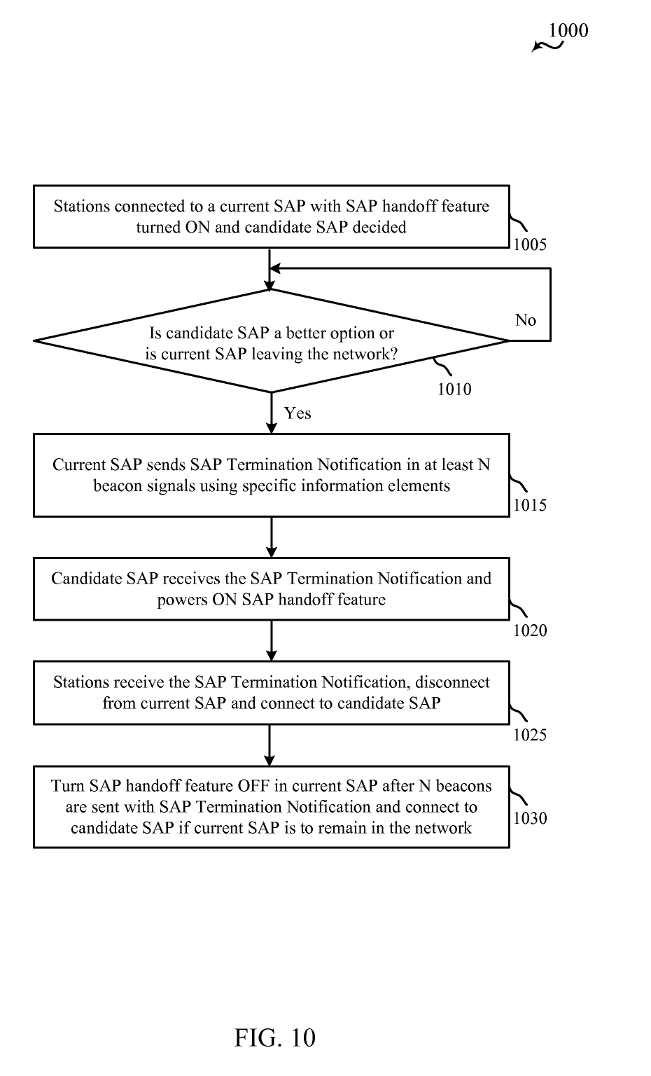

FIG. 10 is a flow chart illustrating an example of a method 1000 for wireless communications in which there is an scheduled termination of a current SAP or a better SAP candidate is available. For clarity, the method 1000 is described below with reference to one of the stations, devices, and components shown in FIGS. 1, 6A, 6B, 14, and/or 15. In one embodiment, one of the stations may execute one or more sets of codes to control the functional elements of the station to perform the functions described below.

At block 1005, station (e.g., stations 115-b in FIG. 6A) may connect to a current SAP with the SAP handoff feature turned ON or enabled. From the connected stations, the current SAP may determine a candidate SAP.

At block 1010, the current SAP may determine whether one of the connected stations that also has the SAP handoff feature turned ON is better suited to be the SAP or whether it is leaving the network (e.g., because of a scheduled termination). When the current SAP is to remain in its present role, the process may return to block 1010, otherwise the process may proceed to block 1015.

At block 1015, the current SAP may send a SAP Termination Notification in at least N beacon signals using specific information elements. The SAP Termination Notification may be a sub-information element within the candidate SAP information elements. Thus, the SAP Termination Notification is in effect a counter of N (pre-determined value) beacons which decrements to 0 to indicate the candidate SAP and all other clients that the SAP will shutdown after N beacon signals. When the counter reaches 0, the current SAP powers OFF.

At block 1020, the candidate SAP receives the SAP Termination Notification and powers ON the SAP handoff feature to start sending beacon signals on the appropriate channel. If the candidate SAP misses the SAP Termination Notification it may start to send beacon signals upon a beacon miss after the current SAP goes OFF completely.

At block 1025, stations receive the SAP Termination Notification, disconnect from the current SAP, and connect instead to the candidate SAP.

At block 1030, the current SAP turns the SAP handoff feature OFF after the N beacon signals are sent with the SAP Termination Notification and proceeds to turn ON in client mode to connect to the candidate SAP if it is to remain in the network.

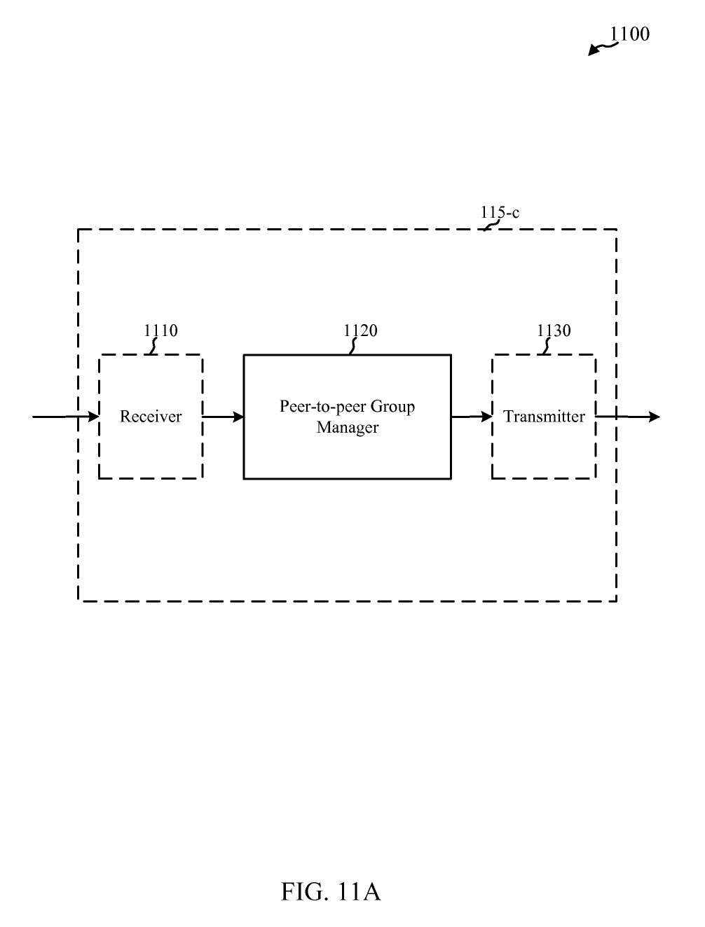

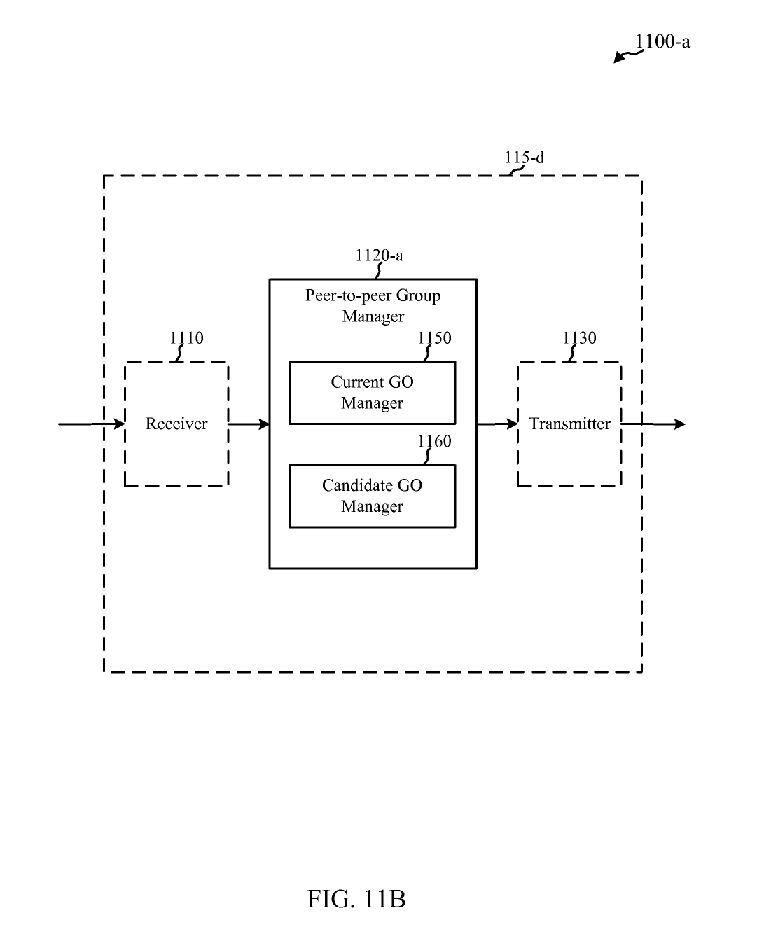

FIG. 11A shows a diagram 1100 having a station 115-c for use in wireless communications that support automatic P2P group recreation when a current GO becomes unavailable. In some embodiments, the station 115-c may be an example of one or more aspects of one of the stations 115 described with reference to FIGS. 1, 2A, 2B, and/or 15. The station 115-c, or portions of it, may also be a processor. The station 115-c may include a receiver 1110, a peer-to-peer group manager 1120, and/or a transmitter 1130. Each of these components may be in communication with each other.

In some embodiments, the receiver 1110 may be or include an RF receiver. The RF receiver may include separate receivers for the different bands. For example, the RF receiver may include a receiver (i.e., part of a radio or modem) operable to receive transmissions in one or more Wi-Fi bands (e.g., 2.4 GHz, 5 GHz). The receiver 1110 may be used to receive various types of data and/or control signals (i.e., transmissions) over one or more communication links of a wireless communications system, such as one or more communication links of the WLAN or Wi-Fi networks described with reference to FIGS. 1, 2A, and/or 2B.

In some embodiments, the transmitter 1130 may be or include an RF transmitter. The RF transmitter may include separate transmitters for the different bands. For example, the RF transmitter may include a transmitter (i.e., part of a radio or modem) operable to transmit in one or more Wi-Fi bands (e.g., 2.4 GHz, 5 GHz). The transmitter 1130 may be used to transmit various types of data and/or control signals (i.e., transmissions) over one or more communication links of the WLAN or Wi-Fi networks described with reference to FIGS. 1, 2A, and/or 2B.

In some embodiments, the peer-to-peer manager 1120 is configured to determine whether a current GO (e.g., current GO in FIG. 2A) in a current group of clients (e.g., P2P network) is unavailable (e.g., left the network, battery runs out). The peer-to-peer manager 1120 may be configured to transmit invitations to clients in the current group to join a next group of clients when a determination is made that the current GO is unavailable and the current group of clients is dissolved in response to the unavailability of the current GO. The peer-to-peer manager 1120 may be configured to form the next group of clients based at least in part on the clients from the current group of clients that accept the invitation to join the next group of clients. Each of the current group of clients and the next group of clients may be configured in a peer-to-peer network.

In some embodiments, the peer-to-peer manager 1120 is configured to determine whether a current GO in a current group of clients is unavailable by detecting that a beacon from the current GO has not been received during a predefined period of time (e.g., heartbeat failure, missed timeout). The peer-to-peer manager 1120 may be configured to transmit invitations to clients in the current group by transmitting invitations to clients in the current group according to a sequence specified by the current GO before the current GO became unavailable. The peer-to-peer manager 1120 may be configured to transmit invitations to clients in the current group according to a sequence specified by the current GO by transmitting an invitation to a next client in the sequence after a current client in the sequence accepts its respective invitation. The peer-to-peer manager 1120 may be configured to transmit invitations to clients in the current group according to a sequence specified by the current GO by waiting a predefined period of time to transmit an invitation to a next client in the sequence when a connection attempt with a current client in the sequence is unsuccessful.

In some embodiments, the peer-to-peer manager 1120 is configured to receive configuration information to enable the station 115-c to operate as GO for the next group of clients, where the configuration information is received from the current GO before the current GO became unavailable. The peer-to-peer manager 1120 may be configured to enable the station 115-c to operate as the GO for the next group of clients when the next group of clients is formed. The peer-to-peer manager 1120 may be configured to form the next group of clients by receiving one or more acceptances to the invitations through a listening channel specified by the current GO before the current GO became unavailable.

FIG. 11B shows a diagram 1100-a having a station 115-d for use in wireless communications that support automatic P2P group recreation when a current GO becomes unavailable. In some embodiments, the station 115-d may be an example of the station 115-c of FIG. 11A. The station 115-d, or portions of it, may also be a processor. The station 115-d may include the receiver 1110, a peer-to-peer group manager 1120-a, and/or the transmitter 1130. Each of these components may be in communication with each other.

The receiver 1110 and the transmitter 1130 are described above with respect to FIG. 11A. The peer-to-peer group manager 1120-a may be an example of the peer-to-peer group manager 1120 of FIG. 11A, and may include a current GO manger 1150 and a candidate GO manager 1160.

The current GO manger 1150 may be configured to handle aspects described at least with respect to FIGS. 1, 2A, 2B, 3, 4, 5, 16, and/or 17 related to operations and functions performed by a current GO before the current GO becomes unavailable.

The candidate GO manger 1160 may be configured to handle aspects described at least with respect to FIGS. 1, 2A, 2B, 3, 4, 5, 16, and/or 17 related to operations and functions performed by a candidate GO before the current GO becomes unavailable and after the GO becomes unavailable and the candidate GO is to operate as a next GO for a next group

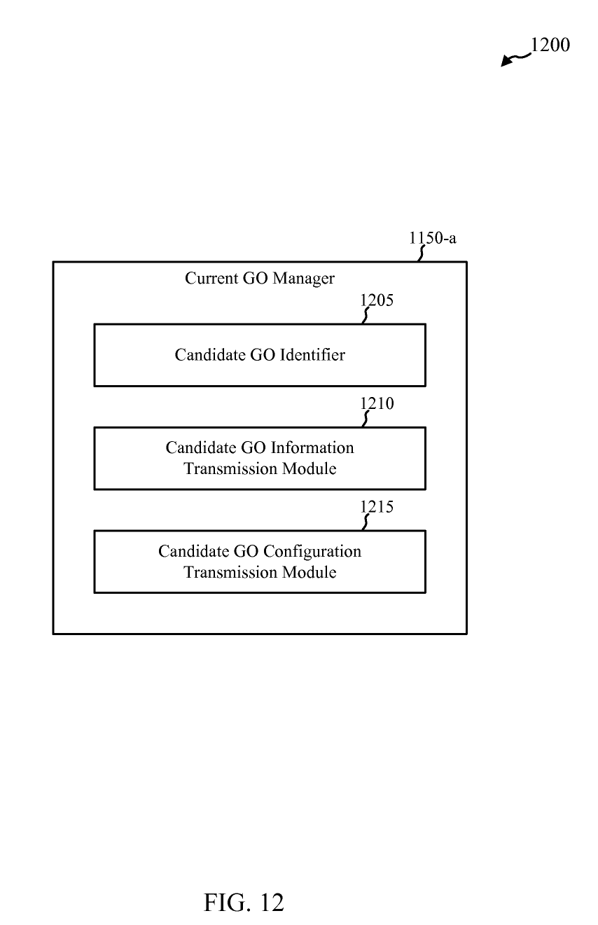

FIG. 12 shows a diagram 1200 having a current GO manager 1150-a that may be an example of the current GO manager 1150 of FIG. 11B. The current GO manager 1150-a, or portions of it, may also be a processor. The current GO manager 1150-a may include a candidate GO identifier 1205, a candidate GO information transmitter 1210, and a candidate GO configuration transmitter 1215. Each of these components may be in communication with each other.

The candidate GO identifier 1205 may be configured to handle aspects described at least with respect to FIGS. 1, 2A, 2B, 3, 4, 5, 16, and/or 17 related to identifying, selecting, and/or changing a candidate GO to be used in case the current GO is unavailable (e.g., terminated).

The candidate GO information transmitter 1210 may be configured to handle aspects described at least with respect to FIGS. 1, 2A, 2B, 3, 4, 5, 16, and/or 17 related to collecting information about a candidate GO and transmitting the information (e.g., by using vendor specific information elements) to clients in the group such that those clients are aware of which client to turn to in case the group dissolves because the current GO is unavailable.

The candidate GO configuration transmitter 1215 may be configured to handle aspects described at least with respect to FIGS. 1, 2A, 2B, 3, 4, 5, 16, and/or 17 related to generate and transmit configuration information to a candidate GO to prepare the candidate GO to take over as GO for a next group when the current group dissolves because the current GO is unavailable.

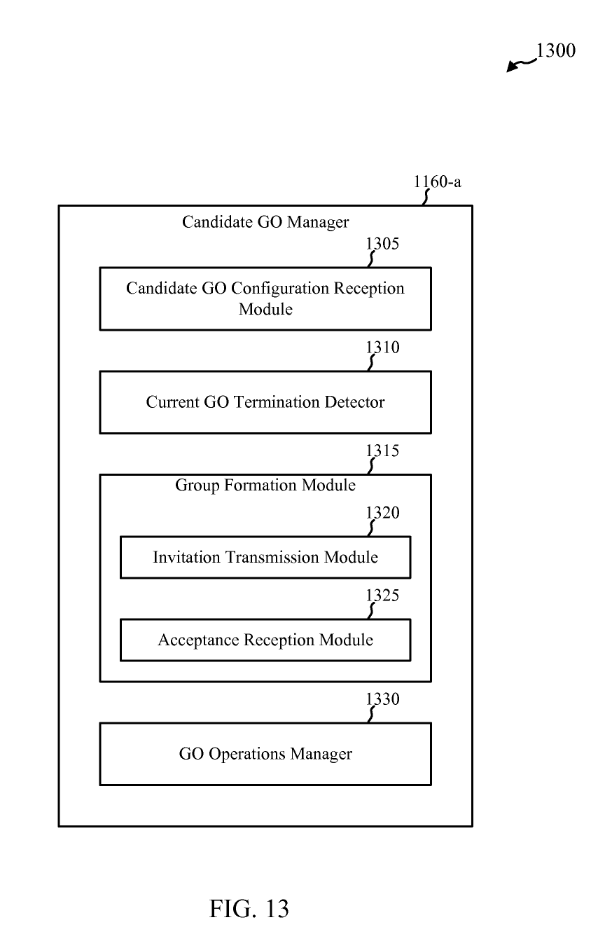

FIG. 13 shows a diagram 1300 having a candidate GO manager 1160-a that may be an example of the candidate GO manager 1160 of FIG. 11B. The candidate GO manager 1160-a, or portions of it, may also be a processor. The candidate GO manager 1160-a may include a candidate GO configuration receiver 1305, a current GO termination detector 1310, a group former 1315, and a GO operations manager 1330. The group former 1315 may include an invitation transmitter 1320 and an acceptance receiver 1325. Each of these components may be in communication with each other.

The candidate GO configuration receiver 1305 may be configured to handle aspects described at least with respect to FIGS. 1, 2A, 2B, 3, 4, 5, 16, and/or 17 related to receiving configuration information from a current GO. The configuration information may include an indication that the device has been selected to be a candidate GO and may also include information to enable the device to operate as the next GO when the current GO becomes unavailable.

The current GO termination detector 1310 may be configured to handle aspects described at least with respect to FIGS. 1, 2A, 2B, 3, 4, 5, 16, and/or 17 related to detecting when the current GO becomes unavailable. For example, the current GO termination detector 1310 may detect when beacon signals from the current GO are not received within a predefined period of time (e.g., heartbeat failure, missed timeout).

The group former 1315 may be configured to handle aspects described at least with respect to FIGS. 1, 2A, 2B, 3, 4, 5, 16, and/or 17 related to forming a next group from clients in the terminated group when the current GO becomes unavailable. The invitation transmitter 1320 may be configured to transmit invitations to clients to join the next group according to a sequence provided by a current GO and the acceptance receiver 1325 may be configured to receive acceptances from those clients.

The GO operations manager 1330 may be configured to handle aspects described at least with respect to FIGS. 1, 2A, 2B, 3, 4, 5, 16, and/or 17 related to having a candidate GO operate as a next GO when the current GO becomes unavailable. In some instances, some or all of the features of the GO operations manager 1330 may be performed by, for example, the current GO managers 1150 and 1150-a.

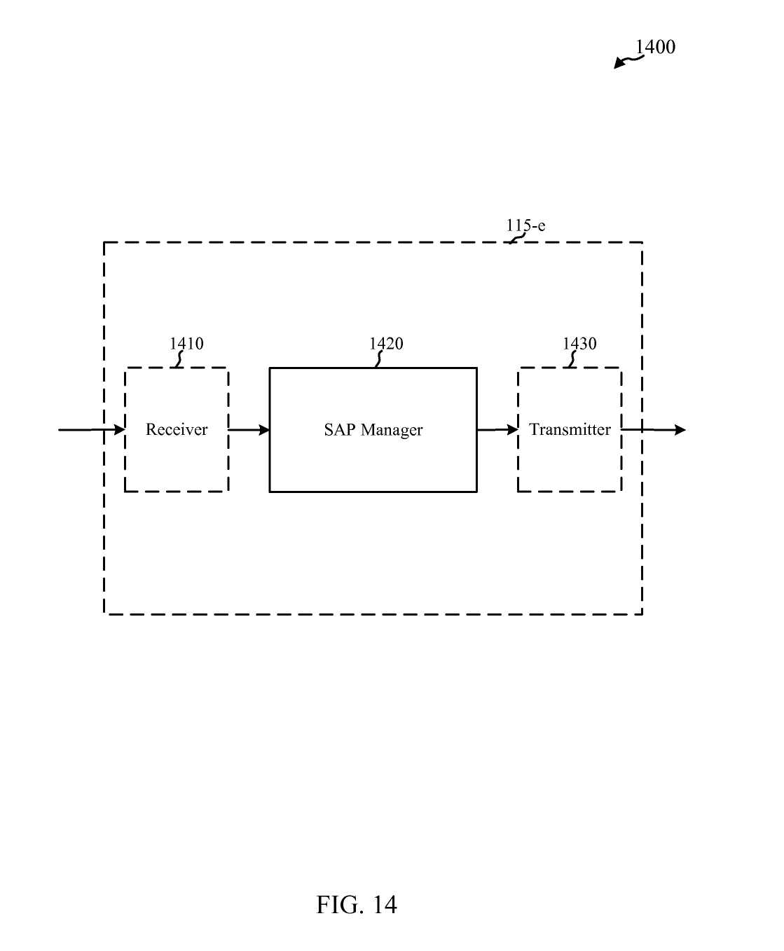

FIG. 14 shows a diagram 1400 having a station 115-e for use in wireless communications that support SAP offload to a candidate SAP when the current SAP becomes unavailable. In some embodiments, the station 115-e may be an example of one or more aspects of one of the stations 115 described with reference to FIGS. 1, 6A, 6B, and/or 15. The station 115-e, or portions of it, may also be a processor. The station 115-e may include a receiver 1410, a SAP manager 1420, and/or a transmitter 1430. Each of these components may be in communication with each other.

In some embodiments, the receiver 1410 may be or include an RF receiver. The RF receiver may include separate receivers for the different bands. For example, the RF receiver may include a receiver (i.e., part of a radio or modem) operable to receive transmissions in one or more Wi-Fi bands (e.g., 2.4 GHz, 5 GHz). The receiver 1410 may be used to receive various types of data and/or control signals (i.e., transmissions) over one or more communication links of a wireless communications system, such as one or more communication links of the WLAN or Wi-Fi networks described with reference to FIGS. 1, 6A, and/or 6B.

In some embodiments, the transmitter 1430 may be or include an RF transmitter. The RF transmitter may include separate transmitters for the different bands. For example, the RF transmitter may include a transmitter (i.e., part of a radio or modem) operable to transmit in one or more Wi-Fi bands (e.g., 2.4 GHz, 5 GHz). The transmitter 1430 may be used to transmit various types of data and/or control signals (i.e., transmissions) over one or more communication links of the WLAN or Wi-Fi networks described with reference to FIGS. 1, 6A, and/or 6B.

In some embodiments, the SAP manager 1420 is configured to have at least one client station (e.g., stations 115-b) with SAP capability indicate to the current SAP at least one parameter relevant to its performance as a potential new SAP for the network. The SAP manager 1420 may be configured to have the current SAP calculate, based at least in part on the indicated parameters, which of the potential new SAPs will be the candidate replacement SAP. The SAP manager 1420 may be configured to have the current SAP inform network clients stations which one has been chosen as candidate replacement SAP in the event that a transition is to be made. The least one parameter may include a maximum number of client stations supported, a type of Internet connection, a channel of operation.

In some embodiments, the SAP manager 1420 is configured to indicate the at least one parameter by using vendor specific information elements in an Association Request packet. The SAP manager 1420 may be configured to inform network client stations by using beacon signals information elements. The SAP manager 1420 may be configured to, upon a new client stations having SAP capability joining the network, have the current SAP recalculate the candidate replacement SAP.

In some embodiments, the SAP manager 1420 is configured to enable a transition from the current SAP to the candidate replacement SAP in the event that the current SAP becomes unavailable to perform an SAP function. The SAP manager 1420 may be configured to, upon the transitioning to the candidate replacement SAP, re-associate client stations in the network with the replacement SAP.

In some embodiments, the SAP manager 1420 is configured to enable a transition from the current SAP to the candidate replacement SAP based at least in part on a comparison between the current SAP and the candidate replacement SAP of the at least one parameter. The SAP manager 1420 may be configured to recalculate the candidate replacement SAP whenever there is a change in the makeup of the client stations having SAP capability.

In some embodiments, the SAP manager 1420 is configured to initiate an application software program to perform the indicating, calculating, or informing regarding each of the client stations having SAP capability. The application software program in each of the client stations having SAP capability may be initiated automatically.

The components of the stations 115-c, 115-d, and 115-e may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

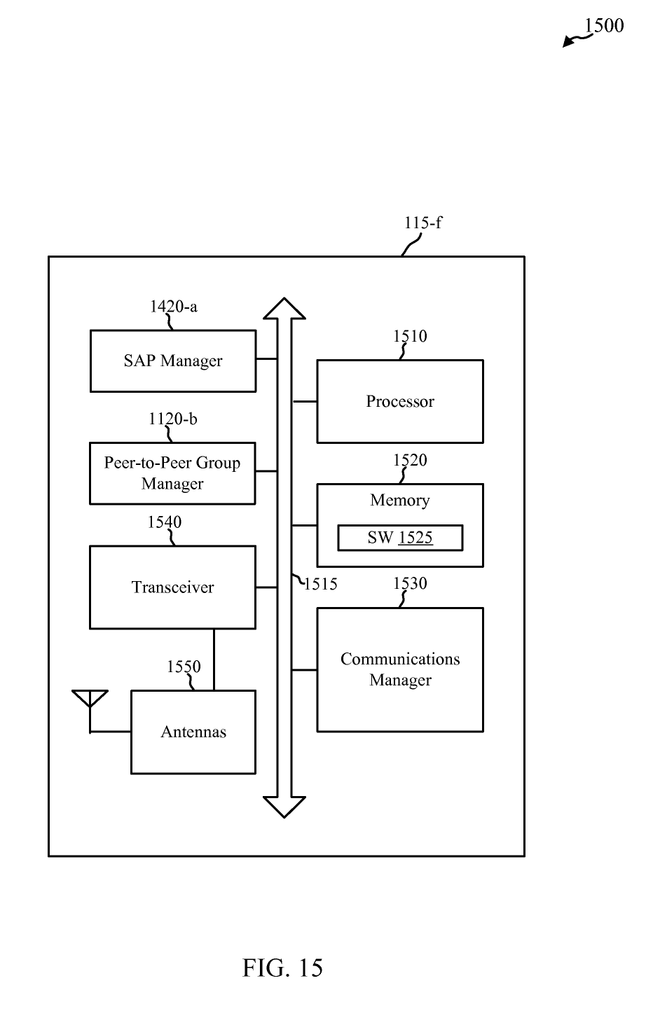

FIG. 15 shows a diagram 1500 that illustrates a wireless terminal or station 115-f configured for automatic P2P group recreation. The station 115-f may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The station 115-f may have an internal power supply (not shown), such as a small battery, to facilitate mobile operation. The station 115-f may be an example of the stations 115, 115-a, 115-b, 115-c, and 115-d of FIGS. 1, 2A, 2B, 6A, 6B, 11A, 11B, and/or 14. The station 115-f may be configured to implement at least some of the features and functions described above with respect to FIGS. 1-14.

The station 115-f may include a processor 1510, a memory 1520, a transceivers 1540, and antennas 1550. The station 115-f may also include a peer-to-peer group manager 1120-b, which may be an example of the peer-to-peer group managers 1120 and 1120-a of FIGS. 11A and 11B, respectively. The station 115-f may also include a SAP manager 1420-a, which may be an example of the SAP manager 1420 of FIG. 14. Each of these components may be in communication with each other, directly or indirectly, over one or more buses 1515.

The memory 1520 may include random access memory (RAM) and read-only memory (ROM). The memory 1520 may store computer-readable, computer-executable software (SW) code 1525 containing instructions that are configured to, when executed, cause the processor 1510 to perform various functions described herein for handling aspects related to automatic recreation of a P2P group in case of GO termination and/or to SAP offloading in case of SAP termination. Alternatively, the software code 1525 may not be directly executable by the processor 1510 but be configured to cause the computer (e.g., when compiled and executed) to perform functions described herein.

The processor 1510 may include an intelligent hardware device, e.g., a central processing unit (CPU), a microcontroller, an ASIC, etc. The processor 1510 may process information received through the transceiver 1540. The processor 1510 may process information to be sent to the transceiver 1540 for transmission through the antennas 1550. The processor 1510 may handle, alone or in connection with the peer-to-peer group manager 1120-b, various aspects of handling automatic recreation of a P2P group in case of GO termination. The processor 1510 may handle, alone or in connection with the SAP manager 1420-a, various aspects of handling SAP offloading in case of SAP termination.

The transceiver 1540 may be configured to communicate bi-directionally with access points (e.g., access points 105, SAP) and/or with other stations (e.g., P2P network). The transceiver 1540 may be implemented as one or more transmitters and one or more separate receivers. The transceiver 1540 may support communications with a WLAN or Wi-Fi network. The transceiver 1540 may include a modem configured to modulate the packets and provide the modulated packets to the antennas 1550 for transmission, and to demodulate packets received from the antennas 1550.

According to the architecture of FIG. 15, the station 115-f may further include a communications manager 1530. The communications manager 1530 may manage communications with various network devices (e.g., access points) and/or with other stations. The communications manager 1530 may be a component of the station 115-f in communication with some or all of the other components of the station 115-f over the one or more buses 1515. Alternatively, functionality of the communications manager 1530 may be implemented as a component of the transceiver 1540, as a computer program product, and/or as one or more controller elements of the processor 1510.

The peer-to-peer group manager 1120-b may be configured to perform various aspects related to operating as a current GO in a current group of clients and/or operating as a candidate GO in a next group of clients. Moreover, some or all of the functionality of the peer-to-peer group manager 1120-b may be performed by the processor 1510 and/or in connection with the processor 1510.

The SAP manager 1420-a may be configured to perform various aspects related to SAP offloading in case of termination of a current SAP or when a better SAP becomes available. Moreover, some or all of the functionality of the SAP manager 1420-a may be performed by the processor 1510 and/or in connection with the processor 1510.

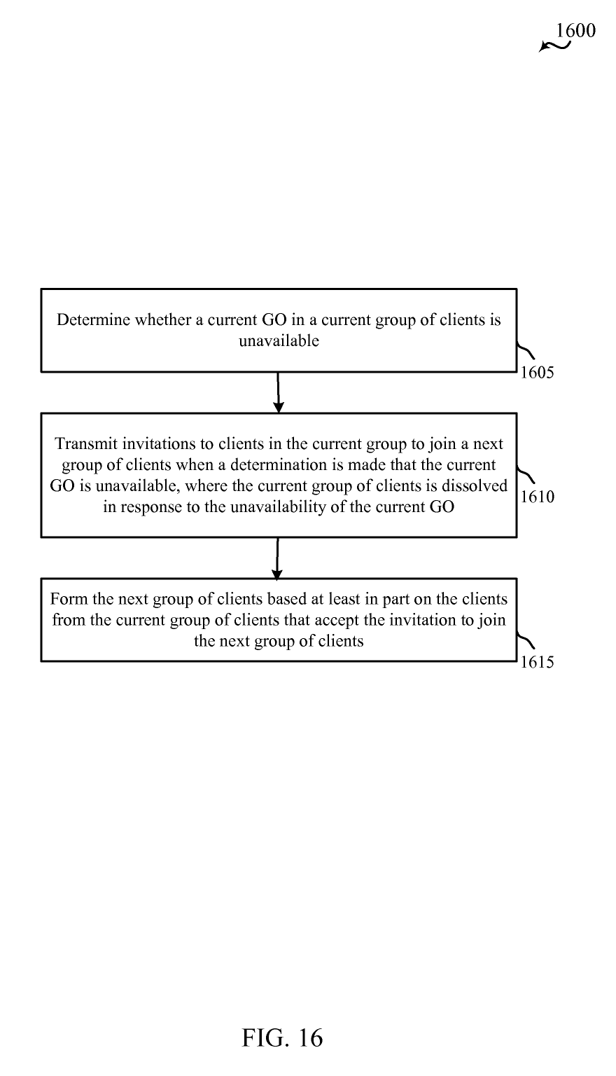

FIG. 16 is a flow chart illustrating an example of a method 1600 for wireless communications. For clarity, the method 1600 is described below with reference to one of the stations, devices, and components shown in FIGS. 1, 2A, 2B, 6A, 6B, 11A, 11B, 12, 13, 14, and/or 15. In one embodiment, one of the stations may execute one or more sets of codes to control the functional elements of the station to perform the functions described below.

At block 1605, a determination is made (e.g., by current GO termination detector 1310) as to whether a current GO in a current group of clients (e.g., P2P network) is unavailable (e.g., left the network, battery runs out).

At block 1610, invitations are transmitted (e.g., by transmitter 1130, invitation transmitter 1320) to clients in the current group to join a next group of clients when a determination is made that the current GO is unavailable and the current group of clients is dissolved in response to the unavailability of the current GO.

At block 1615, the next group of clients is formed (e.g., by group former 1315) based at least in part on the clients from the current group of clients that accept the invitation to join the next group of clients. Each of the current group of clients and the next group of clients is configured in a peer-to-peer network.

In some embodiments of the method 1600, determining whether a current GO in a current group of clients is unavailable includes detecting that a beacon from the current GO has not been received during a predefined period of time. In some embodiments, transmitting invitations to clients in the current group includes transmitting invitations to clients in the current group according to a sequence specified by the current GO before the current GO became unavailable. In some embodiments, transmitting invitations to clients in the current group according to a sequence specified by the current GO includes transmitting an invitation to a next client in the sequence after a current client in the sequence accepts its respective invitation. In some embodiments, transmitting invitations to clients in the current group according to a sequence specified by the current GO includes waiting a predefined period of time to transmit an invitation to a next client in the sequence when a connection attempt with a current client in the sequence is unsuccessful.

In some embodiments of the method 1600, the method includes receiving configuration information (e.g., at a candidate GO) to operate as GO for the next group of clients, where the configuration information is received from the current GO before the current GO became unavailable. The method may include operating as the GO for the next group of clients when the next group of clients is formed. In some embodiments, forming the next group of clients includes receiving one or more acceptances to the invitations (e.g., at the acceptance receiver 1325) through a listening channel specified by the current GO before the current GO became unavailable.

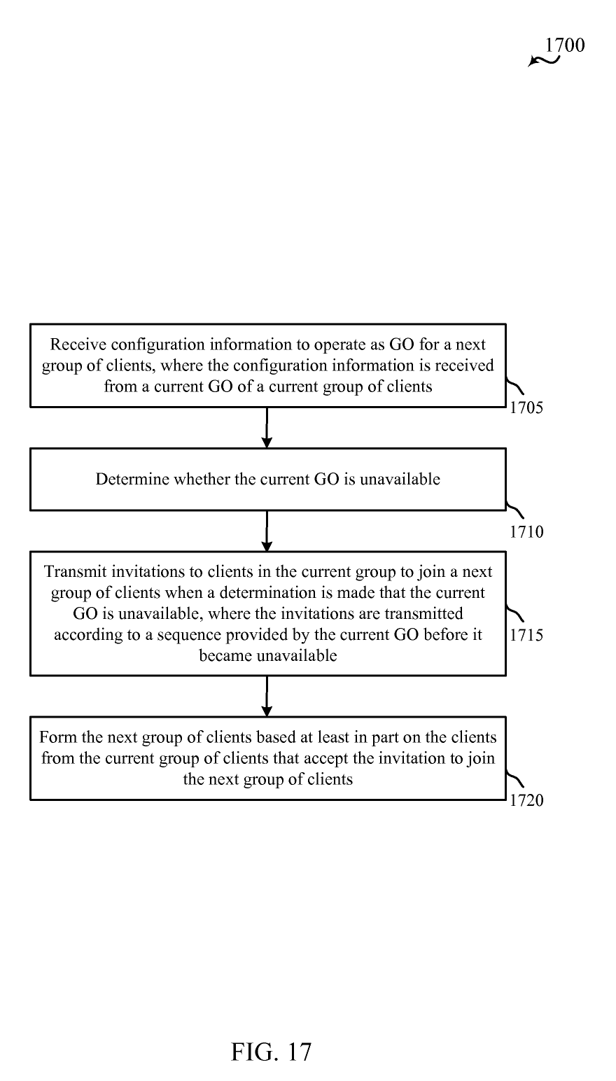

FIG. 17 is a flow chart illustrating an example of a method 1700 for wireless communications. For clarity, the method 1700 is described below with reference to one of the stations, devices, and components shown in FIGS. 1, 2A, 2B, 6A, 6B, 11A, 11B, 12, 13, 14, and/or 15. In one embodiment, one of the stations may execute one or more sets of codes to control the functional elements of the station to perform the functions described below.

At block 1705, configuration information is received (e.g., by candidate GO configuration receiver 1305) to operate as a GO for a next group of clients, where the configuration information is received from a current GO of a current group of clients.

At block 1710, a determination is made (e.g., by current GO termination detector 1310) as to whether the current GO is unavailable (e.g., left the network, battery runs out).

At block 1715, invitations are transmitted (e.g., by transmitter 1130, invitation transmitter 1320) to clients in the current group to join a next group of clients when a determination is made that the current GO is unavailable, where the invitations are transmitted according to a sequence provided by the current GO before it became unavailable.

At block 1720, the next group of clients is formed (e.g., by group former 1315) based at least in part on the clients from the current group of clients that accept the invitation to join the next group of clients. Each of the current group of clients and the next group of clients is configured in a peer-to-peer network.

Thus, the methods 1600 and 1700 may provide for wireless communications. It should be noted that each of the methods 1600 and 1700 is just one implementation and that the operations of the methods 1600 and 1700 may be rearranged or otherwise modified such that other implementations are possible. In some instances, the operations of the methods 1600 and 1700 may be combined to produce other implementations.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communications, comprising:
determining whether a current group owner (GO) in a current group of clients is unavailable;
transmitting invitations to clients in the current group to join a next group of clients when a determination is made that the current GO is unavailable, the current group of clients being dissolved in response to the unavailability of the current GO; and
forming the next group of clients based at least in part on the clients from the current group of clients that accept the invitation to join the next group of clients.

2. The method of claim 1, wherein each of the current group of clients and the next group of clients is configured in a peer-to-peer network.

3. The method of claim 1, wherein determining whether a current GO in a current group of clients is unavailable comprises detecting that a beacon from the current GO has not been received during a predefined period of time.

4. The method of claim 1, wherein transmitting invitations to clients in the current group comprises transmitting invitations to clients in the current group according to a sequence specified by the current GO before the current GO became unavailable.

5. The method of claim 4, wherein transmitting invitations to clients in the current group according to a sequence specified by the current GO comprises transmitting an invitation to a next client in the sequence after a current client in the sequence accepts its respective invitation.

6. The method of claim 4, wherein transmitting invitations to clients in the current group according to a sequence specified by the current GO comprises waiting a predefined period of time to transmit an invitation to a next client in the sequence when a connection attempt with a current client in the sequence is unsuccessful.

7. The method of claim 1, further comprising receiving configuration information to operate as GO for the next group of clients, the configuration information being received from the current GO before the current GO became unavailable.

8. The method of claim 7, further comprising operating as the GO for the next group of clients when the next group of clients is formed.

9. The method of claim 1, wherein forming the next group of clients comprises receiving one or more acceptances to the invitations through a listening channel specified by the current GO before the current GO became unavailable.

10. An apparatus for wireless communications, comprising:
a detector configured to determine whether a current GO in a current group of clients is unavailable; and
a group former configured to:
transmit invitations to clients in the current group to join a next group of clients when a determination is made that the current GO is unavailable, the current group of clients being dissolved in response to the unavailability of the current GO; and
form the next group of clients based at least in part on the clients from the current group of clients that accept the invitation to join the next group of clients.

11. The apparatus of claim 10, wherein each of the current group of clients and the next group of clients is configured in a peer-to-peer network.

12. The apparatus of claim 10, wherein the detector is further configured to detect that a beacon from the current GO has not been received during a predefined period of time.

13. The apparatus of claim 10, wherein the group former is further configured to transmit invitations according to a sequence specified by the current GO before the current GO became unavailable.

14. The apparatus of claim 13, wherein the group former is further configured to transmit of an invitation to a next client in the sequence after a current client in the sequence accepts its respective invitation.

15. The apparatus of claim 13, wherein the group former is further configured to wait a predefined period of time to transmit an invitation to a next client in the sequence when a connection attempt with a current client in the sequence is unsuccessful.

16. The apparatus of claim 10, further comprising a receiver configured to receive configuration information to operate as GO for the next group of clients, the configuration information being received from the current GO before the current GO became unavailable.

17. The apparatus of claim 16, further comprising a GO operations manager configured to implement GO operations for the next group of clients when the next group of clients is formed.

18. The apparatus of claim 10, wherein the group former is further configured to receive one or more acceptances to the invitations through a listening channel specified by the current GO before the current GO became unavailable.

19. A computer program product for wireless communications, the computer program product comprising a non-transitory computer-readable medium storing instructions executable by a processor to cause a processor to:
determine whether a current group owner (GO) in a current group of clients is unavailable;
transmit invitations to clients in the current group to join a next group of clients when a determination is made that the current GO is unavailable, the current group of clients being dissolved in response to the unavailability of the current GO; and
form the next group of clients based at least in part on the clients from the current group of clients that accept the invitation to join the next group of clients.

20. The computer program product of claim 19, wherein each of the current group of clients and the next group of clients is configured in a peer-to-peer network.
